(19) United States
(12) Patent Application Publication
(10) Pub. No.: US 2014/0358823 A1
(43) Pub. Date: Dec. 4, 2014

(54) METHOD AND SYSTEM FOR DISPLAYING PAST RETURNS OF A PREEXISTING INVESTMENT USING A GAME-OF-CHANCE-LIKE GRAPHICAL USER INTERFACE

(71) Applicant: TGG VENTURES LLC, Chicago, IL (US)

(72) Inventors: Andrew Rosenfield, Lake Forest, IL (US); Eliot Abrams, Chicago, IL (US); Thomas Blaser, Chicago, IL (US); Stylianos Constantinides, Chicago, IL (US); Andrew Hogue, Chicago, IL (US); Janet Moehring, Chicago, IL (US); Ian Muir, Chicago, IL (US); Laura Rivera, Chicago, IL (US); Steven Levitt, Chicago, IL (US)

(73) Assignee: TGG VENTURES LLC, Chicago, IL (US)

(21) Appl. No.: 14/290,767

(22) Filed: May 29, 2014

Related U.S. Application Data
(60) Provisional application No. 61/829,690, filed on May 31, 2013.

(51) Int. Cl. G06Q 40/06; G07F 17/32

(52) U.S. Cl. CPC G06Q 40/06; G07F 17/326
USPC 705/36 R

(57) ABSTRACT

A method and system for revealing investment account information including past returns of one or more of the user's preexisting investments is provided. The method and system include providing a query to one or more databases to access and acquire investment account information of the user's preexisting investments. The method and system include obtaining, in response to the query, the investment account information. The method and system also include populating the investment account information to be accessed by a return on investment game-of-chance interface application. The method and system additionally include revealing the investment account information as though the past returns of one or more of the user's preexisting investments were the result of a game-of-chance played by the user on a game-of-chance user interface by operation of the return on investment game-of-chance interface application.

### BACKGROUND OF INVENTION

1. Field of Invention

The present invention relates to methods and systems for displaying past returns of preexisting investments. More particularly, the present invention relates to methods and systems for displaying past returns of preexisting investments using a game-of-chance-like graphical user interface.

2. Description of Related Art

In recent years, more then 90% of Americans held some type of financial asset. Among these, retirement accounts, cash value life insurance, and stocks were the most commonly held assets (see: Changes in U.S. Family from 2007 to 2010: Evidence from the Survey of Consumer Finances). Many investors utilize internet sites, web-based applications, and/or portable device applications installed on portable electronic devices to aid in investing. To accommodate this shift towards online/electronic investing, many financial institutions offer websites, portable device applications, and various graphical user interfaces that allow users to alter their investment(s) and check the value of their investment(s) in or almost in real-time.

The internet sites, web-based applications, and/or portable device applications are utilized by entities such as brokerage firms, banks, companies, etc. to convey information to users about their investment(s) including allocation, initial and current value, and return(s). In most cases, these entities utilize simple graphical user interfaces that show a break down of information in a summarized format. For example, a brokerage firm may offer its users a simple summary of their current positions as well as some graphical analysis of historical returns along with a few breakdowns of the user's portfolio. In another instance, a brokerage firm may offer a graphical representation of the value of the user's investment(s) over time along with allocations across asset types. However, these entities focus exclusively on informing users about the user's investments without putting any emphasis on engaging the users with an appealing, exciting, and/or entertaining graphical user interface.

Thus, the typical user interfaces tends to provide a boring, monotonous, lackluster approach to investing, which makes users less inclined to utilize the websites and applications to attain real-time data regarding their investment(s). Instead of utilizing the websites and applications, in some cases users may tend to take more time to find out simple answers regarding the status of their investment(s) by contacting brokers/customer service agents or waiting for monthly statements to determine whether there have been any changes in their account status, or whether changes should be made.

An increasing number of on-line/portable device games and applications are being developed with entertaining and exciting graphical user interfaces. Online casino style gaming (i.e., card games, slot machines, roulette, craps, baccarat, spinning tops, etc.) and social gaming that produce randomized results have become increasingly popular. A common dimension among successful online games (both skilled and unskilled) is that they entertain the user, present the user with a number of interesting choices and, generate suspense as the user waits to learn about the result of the game. These games keep users engaged with an appealing, exciting, and entertaining interface.

### BRIEF SUMMARY OF THE INVENTION

According to one aspect, a method for revealing investment account information including past returns of one or more of the user's preexisting investments is provided. Specifically in accordance with this aspect, the method includes providing a query to one or more databases to access and acquire investment account information of the user's preexisting investments. The method includes obtaining, in response to the query, the investment account information including the past returns of one or more of the user's preexisting investments. The method also includes populating the investment account information including the past returns of one or more of the user's preexisting investments to be accessed by a return on investment game-of-chance interface application. Additionally, the method includes revealing the investment account information including the past returns of one or more of the user's preexisting investments to the user by operation of the return on investment game-of-chance interface application. The revealing of the investment account information includes revealing the past returns of one or more of the user's preexisting investments as though the past returns of one or more of the user's preexisting investments were the result of a game-of-chance played by the user on a game-of-chance user interface.

According to a further aspect, for revealing to investment account information including past returns of one or more of the user's preexisting investments. Specifically in accordance with this aspect, the system includes a return on investment game-of-chance interface application that is executed on a plurality of electronic devices. The system includes a return on investment processing module that is included as a module of the return on investment game-of-chance interface application that provides a query to one or more databases to access and acquire investment account information of the user's preexisting investment accounts including past returns of one or more of the user's preexisting investments. The system also includes a return on investment intake module that is included as a module of the return on investment game-of-chance interface application that populates investment account information including past returns of one or more of the user's preexisting investments to be utilized by the return on investment game-of-chance interface application. Additionally, the system includes a game-of-chance user interface that is included as a user interface of the return on investment game-of-chance interface application that reveals the investment account information including past returns of the one or more of the user's preexisting investments by operation of the return on investment game-of-chance interface application. The revealing of the investment account information including the past returns is displayed as though the past returns of one or more of the user's preexisting investments were the result of a game-of-chance played by the user on the game-of-chance user interface.

According to still another aspect, a computer readable medium including instructions that when executed by a processor execute a method for revealing to a user past returns of one or more of the user's preexisting investments. Specifically in accordance with this aspect, the method includes providing a query to one or more databases to access and acquire investment account information of the user's preexisting investments. The method includes obtaining, in response to the query, the investment account information including the past returns of one or more of the user's preexisting investments. The method also includes populating the investment account information including the past returns of one or more of the user's preexisting investments to be accessed by a return on investment game-of-chance interface application. Additionally, the method includes revealing the investment account information including the past returns of one or more of the user's preexisting investments to the user by operation of the return on investment game-of-chance interface application. The revealing of the investment account information includes revealing the past returns of one or more of the user's preexisting investments as though the past returns of one or more of the user's preexisting investments were the result of a game-of-chance played by the user on a game-of-chance user interface.

### BRIEF DESCRIPTION OF THE DRAWINGS

In the descriptions that follow, like parts are marked throughout the specification and drawings with the same numerals, respectively. The drawing figures are not necessarily drawn to scale and certain figures can be shown in exaggerated or generalized form in the interest of clarity and conciseness. The disclosure itself, however, as well as a preferred mode of use, further objects and advances thereof, will be best understood by reference to the following detailed description of illustrative embodiments when read in conjunction with the accompanying drawings, wherein:

FIG. 1 is a schematic view of an exemplary return on investment game-of-chance interface system for viewing preexisting investment account information in a game-of-chance and methods according to an embodiment;

FIG. 2A is an illustrative example of an exemplary game-of-chance user interface that presents a slot machine game-of-chance according to an embodiment;

FIG. 2B is an illustrative example of an exemplary game-of-chance user interface that presents a bingo game-of-chance according to an embodiment;

FIG. 3A is a process flow diagram of an overview of an exemplary user session of a return on investment game-of-chance application from the operating environment of FIG. 1 according to an embodiment;

FIG. 3B is an illustrative example of an exemplary game-of-chance user interface that presents a static total investment information screen from the operating environment of FIG. 1 according to an embodiment;

FIG. 4 is a process flow diagram of exemplary investment and gaming details of an exemplary user session of a return on investment game-of-chance application from the operating environment of FIG. 1 according to an embodiment;

FIG. 5 is a process flow diagram of a method utilized during initial use of an exemplary embodiment of the return on investment game-of-chance interface application from the operating environment of FIG. 1 according to an embodiment;

FIG. 6 is a process flow diagram of a method utilized to obtain and populate investment information utilized by an exemplary embodiment of the return on investment game-of-chance interface application from the operating environment of FIG. 1 according to an embodiment; and

FIG. 7 is a process flow diagram of a method utilized during a session of the return on investment game-of-chance interface application from the operating environment of FIG. 1 according to an embodiment.

### DETAILED DESCRIPTION OF THE INVENTION

Various terms are utilized throughout the specification and the appended claims. Unless otherwise specified expressly or by context, such terms are to be accorded the definitions set forth in the following paragraphs.

A “processor,” as used herein, processes signals and performs general computing and arithmetic functions. Signals processed by the processor can include digital signals, data signals, computer instructions, processor instructions, messages, a bit, a bit stream, or other computing that can be received, transmitted and/or detected.

A “bus,” as used herein, refers to an interconnected architecture that is operably connected to transfer data between computer components within a singular or multiple systems. The bus can be a memory bus, a memory controller, a peripheral bus, an external bus, a crossbar switch, and/or a local bus, among others.

A “memory,” as used herein can include volatile memory and/or nonvolatile memory. Non-volatile memory can include, for example, ROM (read only memory), PROM (programmable read only memory), EPROM (erasable PROM) and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM).

An “operable connection,” as used herein can include a connection by which entities are “operably connected”, is one in which signals, physical communications, and/or logical communications can be sent and/or received. An operable connection can include a physical interface, a data interface and/or an electrical interface.

An “input device” as used herein can include devices for controlling different features which include various components, systems, and subsystems. The term “input device” includes, but it not limited to: push buttons, rotary knobs, and the like. The term “input device” additionally includes graphical input controls that take place within a user interface which can be displayed by various types of mechanisms such as software and hardware based controls, interfaces, or plug and play devices.

An “output device” as used herein can include devices that can derive from components, systems, subsystems, and electronic devices. The term “output devices” includes, but is not limited to: display devices, and other devices for outputting information and functions.

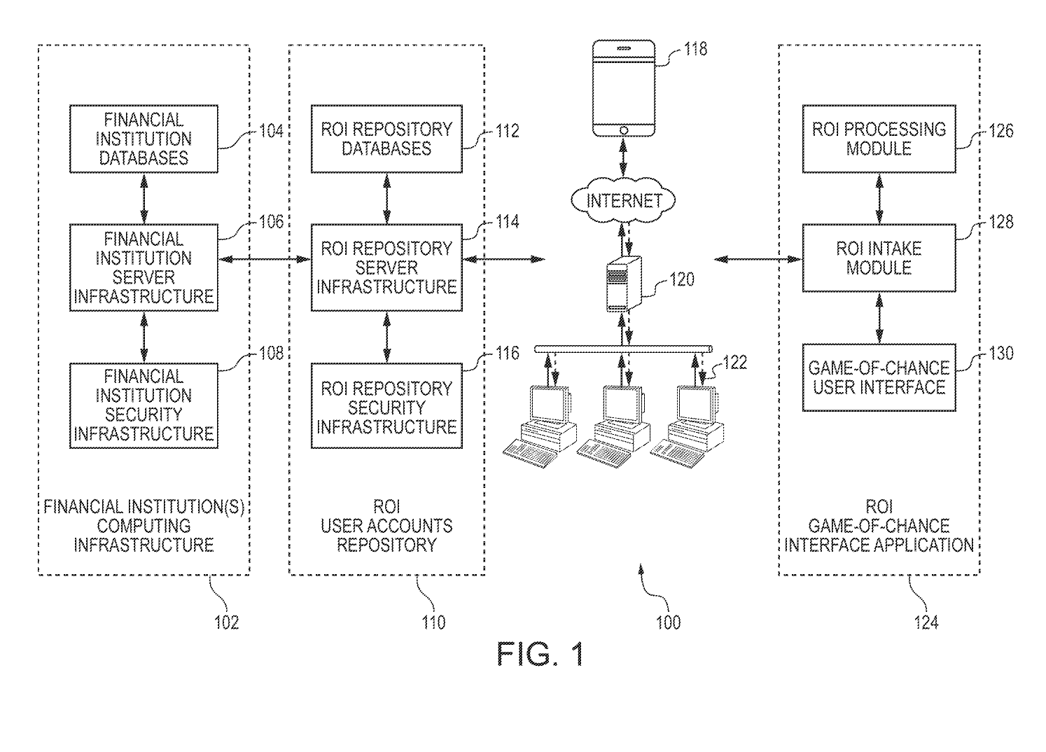

Referring now to the drawings, wherein the showings are for purposes of illustrating one or more exemplary embodiments and not for purposes of limiting the same. FIG. 1 shows schematic view of an exemplary operating environment of a return on investment game-of-chance interface system (ROI game-of-chance interface system) 100 and exemplary methods according to an embodiment. The components of the ROI game-of-chance interface system 100, as well as the components of other systems, hardware architectures and software architectures discussed herein, can be combined, omitted or organized into different architecture for various embodiments. However, the exemplary embodiments discussed herein focus on the environment 100 as illustrated in FIG. 1, with corresponding system components, and related methods.

As shown in the illustrated embodiment of FIG. 1, the ROI game-of-chance interface system 100 provides an overview showing the communications and data transfers between a return on investment game-of-chance interface application (ROI game-of-chance interface application) 124, a return on investment user accounts repository 110 (ROI user accounts repository), and one or more financial institutions that includes financial institution(s) computing infrastructure 102.

In an exemplary embodiment, the ROI game-of-chance interface application 124 utilizes data that is pulled from (e.g., by querying/searching components of) the financial institution's computing infrastructure 102 (by components of the ROI user accounts repository 110) and retained/stored within the ROI user accounts repository 110 to be accessed by the (components of the) ROI game-of-chance interface application 124. The data can be pulled from the computing infrastructure 102 of multiple financial institutions, if necessary. In an alternate embodiment, the ROI game-of-chance interface application 124 can also utilize data that is pushed (i.e., sent) from the financial institution's computing infrastructure 102 (to the components of the ROI user accounts repository 110) and retained/stored within the ROI user accounts repository 110 to be accessed by the (components of the) ROI game-of-chance interface application 124.

Specifically, in an exemplary embodiment, the ROI game-of-chance interface application 124 presents the user with a game-of-chance user interface 130 that provides the user with games-of-chance that can be played by the user to discover facts (e.g., dollar amounts) regarding the user's preexisting investment account(s) information (e.g., return on investment(s)). For example, once the user plays the game-of-chance via the ROI game-of-chance interface application 124, the game-of-chance user interface 130 can reveal data regarding the partial or total past returns of the one or more preexisting investments of the user as through the past returns data (i.e., return on investment(s)) were the result of the game-of-chance being played by the user. The ROI game-of-chance interface application 124 provides the user with an entertaining, appealing, and attractive user interface that engages users (i.e., investors) and provides them with important investment data. Specifically, as the user plays the game-of-chance, the game-of-chance user interface 130 can provide users with an incremental breakdown or total value of the one or more preexisting investments.

The user can play a series of games-of-chance that include but are not limited to high-low, bingo, keno, lotteries, slot machines, roulette, dice games, spinning tops, baccarat, horse racing, craps, and blackjack. The game-of-chance user interface 130 can output data regarding various types of investments including but not limited to securities, bonds, treasury bills, certificates of deposit, interest rate futures, stocks, stock options, equity futures, currency swaps, foreign exchange swaps, commodities, commodity futures, and commodity options.

The ROI game-of-chance interface application 124 is executed on one or more stationary computing devices 122 (e.g., a desktop computer) and/or portable electric devices 118 (e.g., a handheld device, a mobile device, a smart phone, a laptop, a tablet, and an e-reader.) In an exemplary embodiment, the ROI game-of-chance interface application 124 is a software application that is installed directly onto memory (not shown) of the stationary computing device(s) 122 and/or the portable electronic device(s) 118. In another embodiment, the ROI game-of-chance interface application 124 and/or one or more of the components of the ROI game-of-chance interface application 124 can be installed externally from the memory of the portable electronic device 118 and/or the stationary computing device(s) 122. For example, the ROI game-of-chance interface application 124 can include a web based application that is accessed by a communication device (not shown) of the portable electronic device(s) 118 and/or the stationary computing device(s) 122.

As a web based application the ROI game-of-chance interface application 124 can be installed on one or more web servers 120 that host the ROI game-of-chance interface application 124 to be accessed by numerous portable electronic devices 118 and/or stationary computing devices 122 via the internet. In other embodiments, the ROI game-of-chance interface application 124 can include a cloud based application that resides on an external host server such as the web server(s) 120 but is accessed through a viewer application that is installed on the memory of the portable electronic device(s) 118 and/or the stationary computing device(s) 122.

The ROI game-of-chance interface application 124 is presented to the user through a display (not shown) of the portable electronic device(s) 118 and/or connected to the stationary computing device(s) 122 via the game-of-chance user interface 130. The game-of-chance user interface 130 can display the game-of-chance in various forms that are in accordance with the numerous games or chances discussed above.

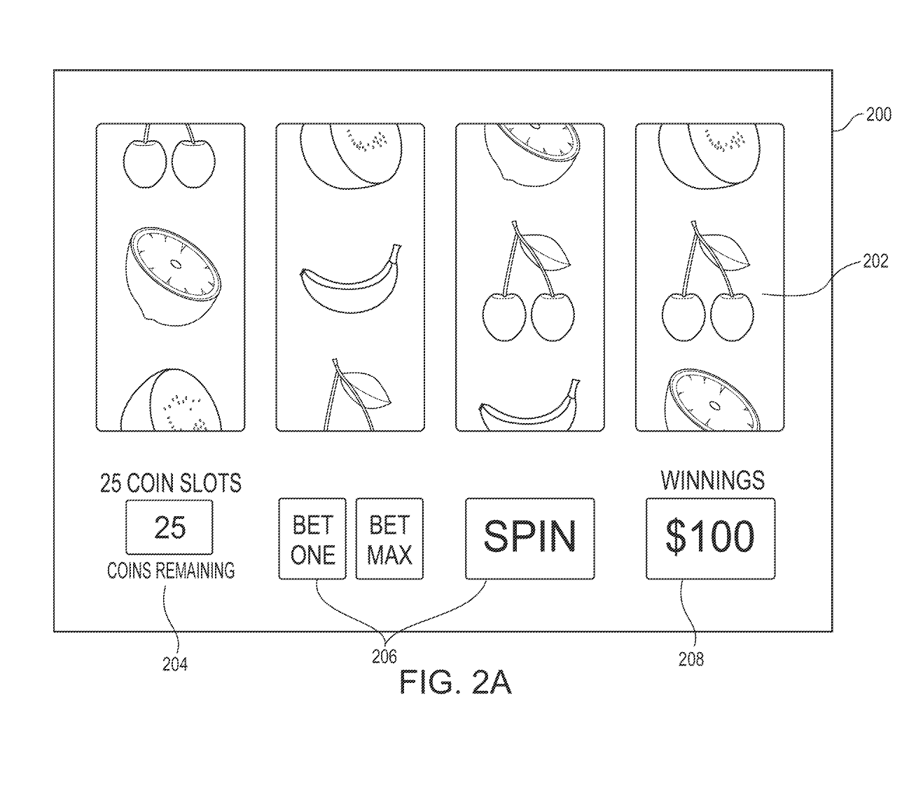

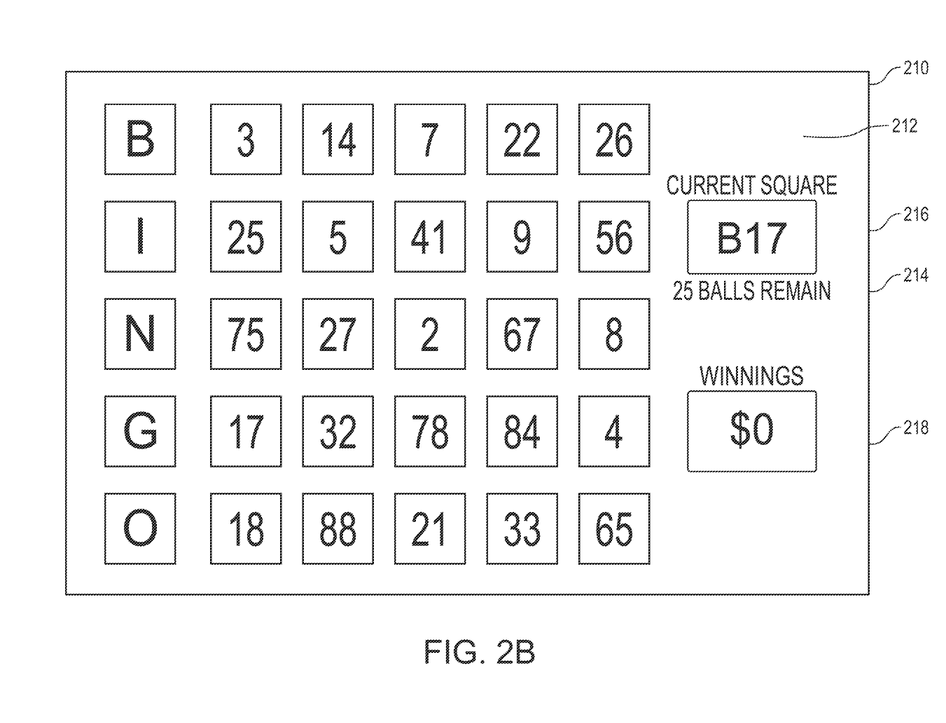

FIG. 2A is an illustrative example of an exemplary game-of-chance user interface 200 that presents the game-of-chance as a slot machine game. FIG. 2B is an illustrative example of an exemplary game-of-chance user interface 210 that presents a game-of-chance as a bingo game. As shown in both FIGS. 2A and 2B, in an exemplary embodiment, the game-of-chance user interface 200, 210 presents the user with the game-of-chance 202, 212, a balance of the number of tokens that are utilized to play rounds of the game-of-chance 204, 214 (tokens are characterized in accordance with the game-of-chance being played), user input icons that are utilized to play the game-of-chance 206, 216, and the current winnings 208, 218.

With reference back to FIG. 1, in one embodiment, the game-of-chance user interface 130 presents current winnings to the user as the return on one or more preexisting investments and/or the current total value of one or more preexisting investments over a specific/fixed period of time (i.e., the preexisting investments+the return on investments) based on the user's account information that is input onto a user's profile within the game-of-chance interface application 124, as described in more detail below. The game-of-chance user interface 130 can also present current winnings to the user as the return on investments and/or the current total value of investments of more than one of the user's preexisting investments with more than one financial institution based on the user's account information for each preexisting investment at each financial institution that is input onto the user's profile within the game-of-chance interface application 124.

The game-of-chance user interface 130 can present the winnings as a cumulative figure of the return on investments of more than one of the user's preexisting investments. For example, if the user inputted numerous stock portfolio accounts within a user profile of the game-of-chance interface application 124 to be accessed and utilized within the game-of-chance, the game-of-chance user interface 130 can present current winnings by showing the total return on investments of the numerous stock portfolio accounts as a cumulative winnings figure (as a single figure for all investments). In one embodiment, the user is presented with a list of preexisting investment accounts that the user previously entered within the user profile of the game-of-chance interface application 124 which the user can selectively choose to utilize within the game-of-chance. The game-of-chance user interface 130 will accordingly only present preexisting investment account information (e.g., returns on investments and/or the current total value of investments) as winnings of the games-of-chance of those preexisting investment accounts that the user selected.

As the user logs in to play the game-of-chance within the game-of-chance interface application 124, the user starts a session. The session can include a single or many rounds where the end of the round is defined as the first instance when the user can stop the game and can be presented with the outcome of the game play. For example, a round can conclude when a slot-machine's reels are spun and stopped and the winnings are calculated. Similarly, a round can conclude in blackjack when one hand of cards are dealt, revealed, and a winner determined. The rounds in one or more sessions can be played on a variety of games-of-chance. In an exemplary embodiment, at the end of the session the user is provided with investment account(s) information including the total returns of his/her preexisting investment via the game-of-chance user interface 130. The session, by definition, ends when the investment account(s) information has been revealed. Since the outcome of the session reveals the user's investment accounts information that includes returns on preexisting investment(s), the outcome (i.e., winnings) of the games-of-chance can be controlled so that the outcome for the sessions are unpredictable to the user.

The user can have agency with regards to how many rounds are played in a session and what games-of-chance are played. However, since the winnings of the game are partly determined by the return on investment(s) of preexisting investments that take place in a financial marketplace, the user does not have control over the outcome of each round and/or each session. In addition, the user's actions in the game have no impact on the size, allocation, or returns of the user's investment(s). The outcome of each round is essentially random, mimicking the expected outcomes of the relevant game. In one embodiment, the outcomes of the rounds will be designed to mimic the variation in outcomes in the relevant game but eventually must converge to the preexisting account information including past returns of the investment. The final outcome of the session will depend solely on the preexisting account information including past returns of the investment.

In an exemplary embodiment, the number of tokens that the user receives at the beginning of the session is a function of the amount invested (higher levels of investment correspond to more tokens per session) and the volatility of the investment (more volatile investments correspond to more tokens per session). In an alternate embodiment, the user can purchase tokens to be utilized to play rounds of a variety of games-of-chance via the game-of-chance user interface 130. In some embodiments, the user will be given the option to earn more tokens as the user increases his or her investment or plays more sessions within the ROI game-of-chance interface application 124. In yet another embodiment, the number of tokens that the user receives is a function of the amount invested, however the user can purchase additional tokens when the original amount of tokens have run out.

In an exemplary embodiment, as the user nears the last of the remaining tokens, the outcomes will be such that the total winnings of the session converge to reveal the past returns of the preexisting investment(s). As the user is playing the game-of-chance during each round, winnings are presented to the user from one preexisting investment account for a period of time divided by increments of profit or loss based on the length of the session. When the user is playing the game-of-chance during each round, winnings are presented to the user for multiple preexisting investments as cumulative investment returns from multiple preexisting investment accounts for a period of time divided by increments of profit or loss based on the length of the session. For example, if the user has a total of twenty-five tokens and if each spin of the game-of-chance slot machine requires five tokens, the user's return on investment(s) can be shown in five increments of positive or negative changes in the value of the total preexisting investment(s) as winnings after each spin (i.e., round) until the session is over.

A certain number of tokens can be used to “buy” a round of a game-of-chance. Tokens can be characterized by different names that pertain to different games-of-chance. For example, tokens can be characterized by one or more bets, one or more hands, one or more spins, one or more balls, one or more coins, one or more credits, and/or one or more chips etc. In addition, tokens can have different values and can be utilized for different types and lengths of game play. For example, the user can choose to “spend” (e.g., “bet”) all of his or her tokens on a round and have a short session. Alternatively, the user could spend one token per round (e.g., one token per black jack hand, slot machine spin, etc.) and experience a much longer session.

The user can also spend tokens across a variety of games, switching games between rounds. At the conclusion of one round, when the user has a sufficient amount of tokens remaining, the user can choose to start a new round and the return on investment(s) will continued to be shown in increments until user's has used all of the tokens or ends the session at which point the user can view the total return on investment(s).

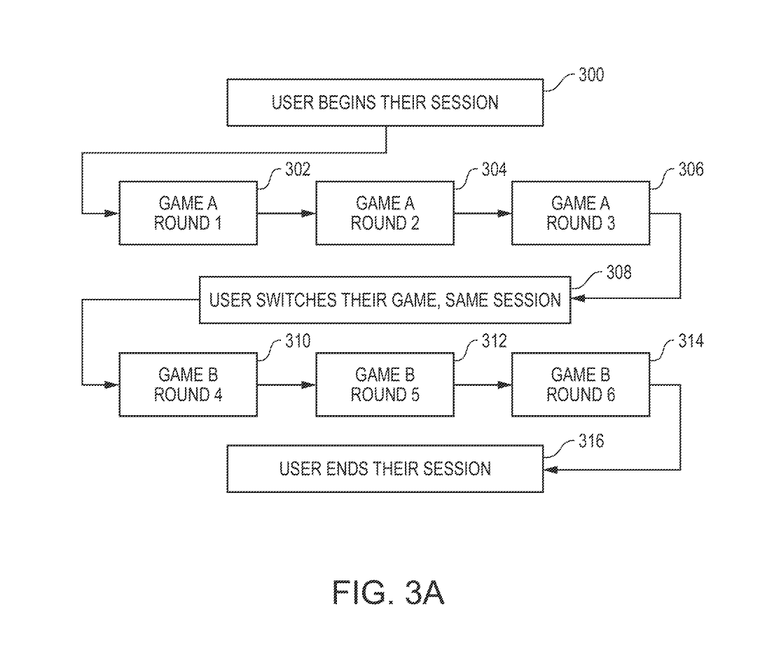

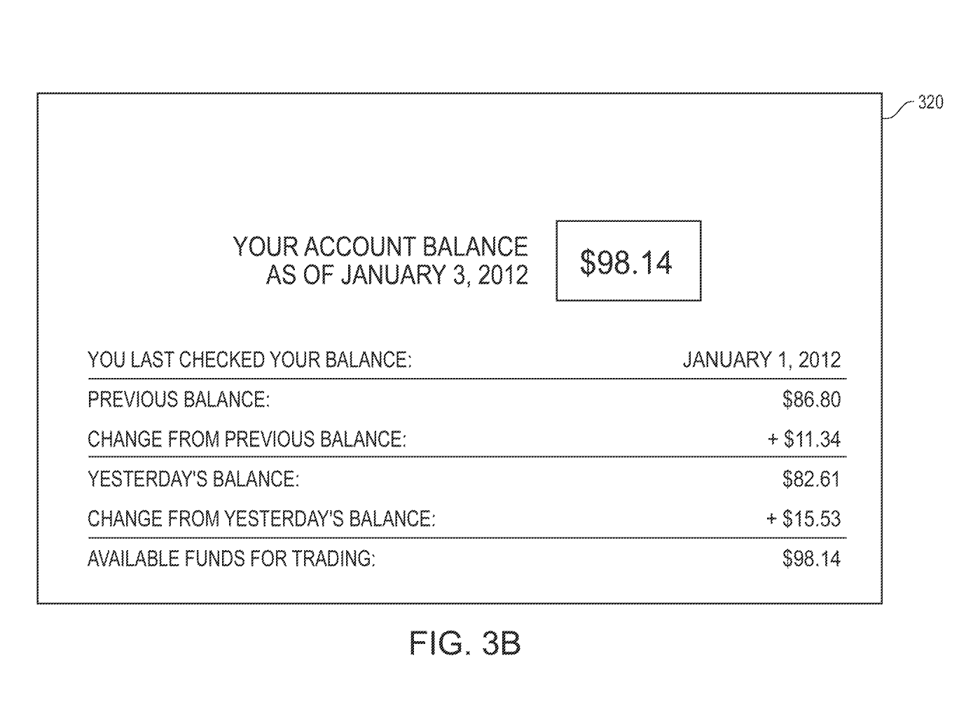

FIG. 3A is a process flow diagram of an overview of an exemplary user session of the ROI game-of-chance application 124. As shown, at 300 the user starts the exemplary user session. At 302-306 the user plays three rounds of ‘Game A’ (e.g., three hands of blackjack). The user can then choose to switch and play a different game-of-chance at 308 within the same session if the user still has the required amount of remaining tokens in order to play more rounds. At 310-314 the user can choose to switch over to ‘Game B’ and play three rounds (e.g., three spins of slot machine) until the user decides to end his or her session at 316. At the end of the session, the user is presented with a total investments returns screen that provides static details regarding one or more preexisting investments.

FIG. 3B is an illustrative example of an exemplary game-of-chance user interface that presents the total investment returns screen 320. In an exemplary embodiment, at the end of each session the user is presented with the static representation of the preexisting investment(s) information that includes the previous investment(s) balance, the returns on investment(s) (change from previous balance), among other optional information. In one embodiment, the user can choose to end the session at any point throughout the session, or between rounds, to view the static representation of the preexisting returns on the total investment returns screen 320. The user can also be forced to end the session and the total investment returns screen 320 appears. For example, when the user is out of tokens, the session ends and the user can view the total returns on his/her investment(s) from a past, fixed time period.

In an alternate embodiment, when the user chooses to terminate the session before playing through all of the rounds, a message will appear on the game-of-chance user interface 130 that warns the user that the current winnings shown may not accurately reflect the investment returns. In one embodiment, the total investment returns screen 320 will only appear if the user completes the current round and/or session to ensure that the user will remain intrigued and engaged into finding out details regarding his or her investment.

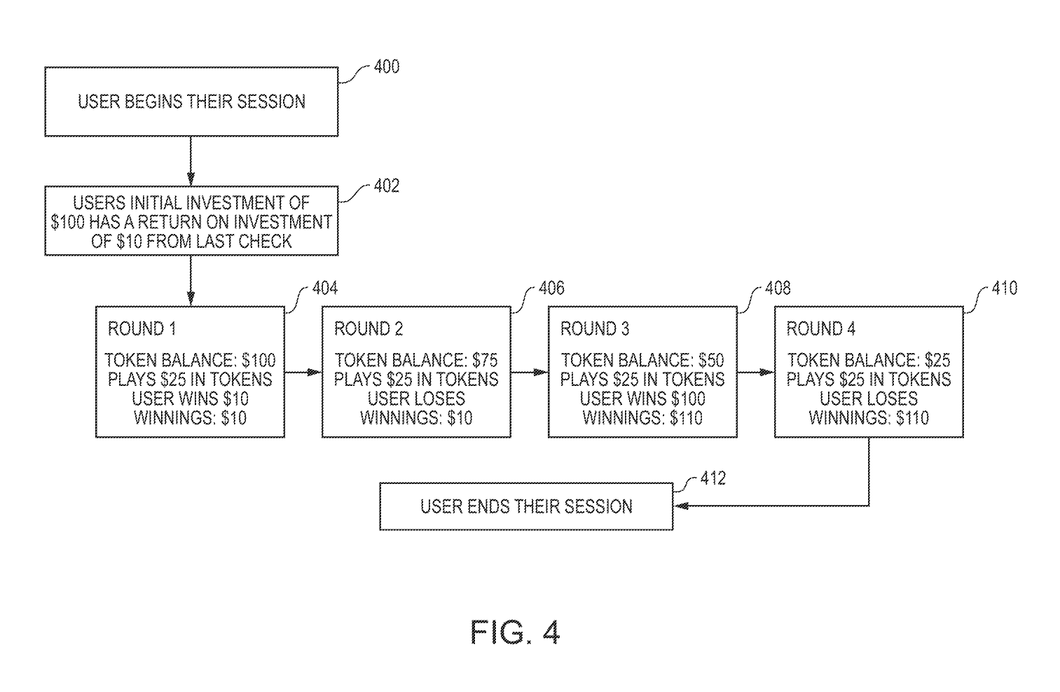

FIG. 4 is a process flow diagram of exemplary investment and gaming details of an exemplary user session of the ROI game-of-chance interface application 124. As shown in this example, the user begins the session of the ROI game-of-chance interface application 124 at 400. In the context of this example, the user initially invested $100 and that amount remains as the preexisting investment. At 402, the user's initial preexisting investment has a return on investment of $10. Therefore, the total value of the preexisting investment is $110. As the user begins to play round one of game-of-chance, the user does not yet know the value of the returns on investment and is given (or purchases) $100 worth of tokens (in this case $1=1 token) to reveal these returns. At 404, during the first round, the user plays $25 worth of tokens and the user wins the round with $10 and observes $10 in winnings as a result of the round and has $75 worth of tokens left which the user carries over to the second round. At 406, during the second round, the user plays $25 worth of tokens and the user loses the round. The user continues to observe $10 in winnings as a result of the round and has $50 worth of tokens left which the user carries over to the third round. At 408, during the third round, the user plays $25 worth of tokens and the user wins the round with $100 and observes $110 in winnings and has 25 worth of tokens left which the user carries over to the fourth round. At 410, during the fourth round, the user plays $25 worth of tokens and the user loses the round. The user continues to observe $110 in winnings and has no tokens left. The game-of-chance session ends after the 4th round as the user has “spent” all of his/her tokens. The winnings of $110 are equivalent to the total (current) preexisting investment account balance and reveal that the returns on investment is $10 on the total investment returns screen when the user ends their session at 412.

It is to be appreciated that the results of each round and or session can show different breakdowns of the return of investment or the total value of one or more preexisting investments. As show in FIG. 4, the result of each round is configured to reflect increments of the total value of the preexisting investment as each round passes taking into account the initial value of the preexisting investment, the return on investment, the value of the tokens, the balance of the tokens, and the user's desire to continue playing the game-of-chance. It can also be appreciated that other investment related information can be shown as the result of each round and/or session that is not limited to a return of investment or total investment value. For example, earnings, profits, losses, appreciation, depreciation, interest, total account balance from multiple accounts, etc. can also be shown as the result of the game-of-chance in alternate embodiments.

With reference back to FIG. 1, the components that enable operation of the ROI game-of-chance interface application 124 will now be discussed in more detail. In an exemplary embodiment, the ROI user accounts repository 110 can be an externally hosted repository of data that is exclusively utilized to provide preexisting investment data along with all related data to the ROI game-of-chance interface application 124. The ROI user accounts repository 110 receives this data from one or more financial institutions. In one embodiment, upon receiving the data, the ROI user accounts repository 110 stores and retains the data for each preexisting investment account for numerous users into return on investment repository databases (ROI repository databases) 112 that are hosted on a return on investment repository server infrastructure (ROI repository server infrastructure) 114. The ROI repository server infrastructure 114 can include but is not limited to web servers, data servers, database servers, domain controllers, backup servers, and the like.

In one embodiment, when the ROI game-of-chance interface application 124 is stored and run locally, the ROI game-of-chance interface application 124 communicates via computer communication to the ROI repository server infrastructure 112 of the ROI user accounts repository 110 via the communication device (not shown) of the portable electronic device(s) 118 and/or the stationary computing device(s) 122. In an alternate embodiment, when the ROI game-of-chance interface application 124 is hosted on the web server(s) 120, the communication device(s) of the web server(s) is utilized to communicate directly to the ROI repository server infrastructure 112 of the ROI user accounts repository 110.

In the exemplary embodiment of FIG. 1, financial intuition(s) server infrastructure 106 can consist of a plurality of interconnected servers that support and maintain customer investment data within one or more financial institution(s) databases 104 that are hosted on a financial institution(s) server infrastructure 106. The financial institution(s) server infrastructure 106 can include but is not limited to web servers, data servers, database servers, domain controllers, backup servers, and the like. The financial institution(s) databases 104 contains users preexisting investment details, along with the user's account details, return on investment details, account history, and profile information.

In an exemplary embodiment, the ROI user accounts repository 110 utilizes user accounts information that is provided directly by the user on the user profile of the ROI game-of-choice interface application 124 in order to access the user's preexisting investment data. Specifically, the ROI user accounts repository 110 utilizes user profile login credentials to access one or more of the user's preexisting investment accounts from one or more financial institutions that contain/maintain the user's preexisting investments. The one or more financial institutions can consist of but are not limited to investment banks, depository banks, brokerage firms, underwriters, pension funds, trust companies, etc.

In one embodiment, the ROI user accounts repository 110 accesses the financial institution(s) via a web portal (e.g., web based application programming interface) that is provided by the financial institution(s) to provide web based access and services to customers (i.e., users) to access their investment accounts, preexisting investment information, account information, and to buy, sell, trade, etc. their investments. Upon successfully utilizing the credentials to access the web portal as an entry point to the user's investment data held by the financial institution(s), the ROI user accounts repository 110 acquires access to financial institution(s) computing infrastructure 102 to retrieve data regarding the user's preexisting investments that reside on the financial institution(s) databases 104.

In an alternate embodiment, return on investment repository security infrastructure (ROI repository security infrastructure) 116 is configured to connect to an extranet network to communicate with financial institution(s) security infrastructure 108 of one or more financial institutions to access the financial institution(s) computing infrastructure 102. For example, security settings and rules (e.g., firewall rules, network address translation rules, virtual private network configurations, HTTP protocols, etc.) can be programmed on both sides of the connections on the financial institution(s) security infrastructure 108 and the ROI repository security infrastructure 116 to facilitate computer communication between the ROI user accounts repository 110 and the financial institution(s) computing infrastructure 102 in order to access the user's preexisting investment(s) data.

In one embodiment, the ROI user accounts repository 110 accesses the financial institution(s) computing infrastructure 102 per a schedule (i.e., hourly or daily basis) to access the user's preexisting investment information. In an alternate embodiment, the ROI user accounts repository 110 only accesses the financial institution(s) computing infrastructure 102 upon receiving a query request from the ROI game-of-chance interface application 124.

Upon accessing the financial institution(s) computing infrastructure 102, a query is run on the financial institution(s) databases 104 to acquire raw data on one or more of the user's preexisting investment accounts information. The raw data of the user's preexisting investment account(s) information can contain account profile information, account numbers, account type, primary data regarding financial numbers, codes, and/or prices related to one or more investments. The raw data can include extra data (that is not applicable for the current use), encoded data, and/or unformatted data.

The raw data of the user's preexisting investment information is copied and transferred directly to the ROI repository server infrastructure 114 where it is processed by a computer program (not shown) into a format that can be specifically utilized by the ROI game-of-chance interface application 124. Once the raw data is processed, it is stored within the ROI repository databases 112 to be accessed by the ROI game-of-chance interface application 124 when required. For example, the raw data can be processed by the computer program to be validated and formatted into specific categories that include but are not limited to user profile data, initial investment value, earnings, profits, losses, appreciation, depreciation, interest, return on investment, and account balance.

The ROI repository databases 112 holds individual records of processed data for each of the preexisting investment accounts from one or more financial institutions. In one embodiment, the ROI user accounts repository 110 gathers raw data of multiple preexisting investments from one or more financial institutions according to information provided by the user on the user's profile within the ROI game-of-chance interface application 124. The records are processed and combined by the ROI repository server infrastructure 114 in order to provide cumulative data pertaining to the user's multiple preexisting investment accounts. For example, if the user added multiple preexisting investment accounts within the user profile of the ROI game-of-chance interface application 124 with the intention that cumulative returns on investment and/or the total value of preexisting investments will be shown (in increments/in total) as winnings on the game-of-chance user interface 130 (while playing the game(s)-of-chance), the ROI repository server infrastructure 114 can combine/merge preexisting investment account information to be stored as a single record of cumulative preexisting investment account data within the ROI repository databases 112.

In the exemplary embodiment shown in FIG. 1, the game of chance interface application 124 includes a return on investment processing module (ROI processing module) 126 that provides a query on the ROI repository databases 112 to access the processed preexisting investment account data from the ROI user accounts repository 110. In an alternate embodiment, the ROI processing module 126 directly connects to the financial institution(s) computing infrastructure 102 to access the financial institution(s) databases 104 for direct acquisition of raw preexisting investment account data to be converted by the ROI processing module 126. However, in some instances where multiple preexisting investment accounts exist within multiple financial institutions, it is preferred that such data be processed by the ROI user accounts repository 110 to efficiently execute/run the ROI game-of-chance interface application 124.

Upon acquiring the processed preexisting investment account data, the ROI processing module 126 sends this data to a return on investment intake module (ROI intake module) 128. The ROI intake module 128 populates relevant aspects of the processed preexisting investment(s) data that is associated to the user to be shown by the game-of-chance user interface 130 as winnings as the user is playing the game(s)-of-chance. In one embodiment, the ROI intake module 128 populates and stores the data provided by the ROI processing module 126 into a local data store within the memory of the portable electronic device(s) 118 and/or stationary computing device(s) 122. In an alternate embodiment, the ROI intake module 128 populates and stores the data provided by the ROI processing module 126 into the one or more webservers 120. Upon playing the game(s)-of-chance, the game-of-chance user interface 130 provides information to the user derived from the data provided by the ROI intake module 128 as winnings that are associated with each round and/or session of the game(s)-of-chance.

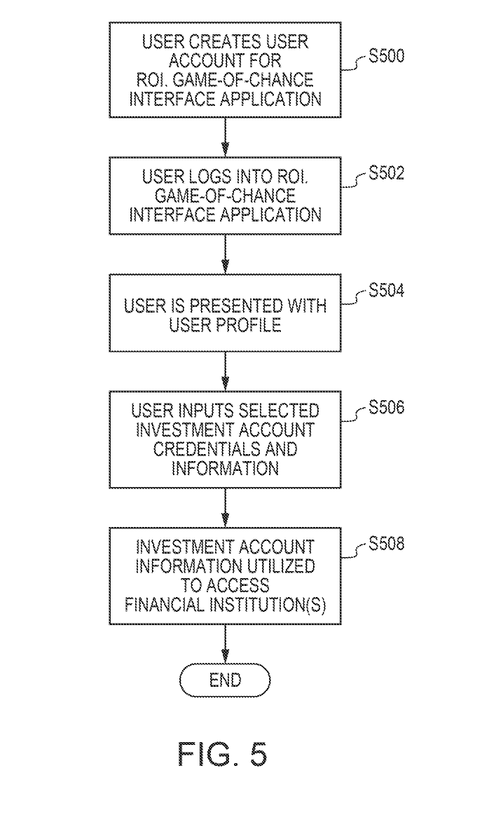

Exemplary methods of the ROI game-of-chance interface system 100 will now be discussed in more detail with reference to FIGS. 5-7. FIG. 5 is a process flow diagram of a method utilized during the user's initial use of an exemplary embodiment of the return on investment game-of-chance interface application 124. The method begins as the user executes the ROI game-of-chance user interface application 124 and executes the application via the portable electronic device(s) 118 and/or stationary computing device(s) 122. At S500, the user creates a user account that corresponds to the user for login to the ROI game-of-chance interface application 124. In an exemplary embodiment, the user is presented with a user account creation registration user interface page that allows the user to create a username and password to login to the ROI game-of-chance interface application 124.

At S502, the user logs into the ROI game-of-chance interface application 124 with the user account credentials created by the user during initial registration of the user account at S500. Upon the initial login of the user's account, at S504, the user is presented with the user profile on the game-of-chance user interface 130. As mentioned above, the user profile allows the user to input credentials to link to and access one or more preexisting investment accounts that are managed by one or more financial institutions. At step S506, the user inputs selected investment account(s) credentials and required information that pertains to the preexisting investment account(s). For example, if the user has two investment accounts in two different financial institutions, the user can be asked to input the name of each of the financial institutions, along with the user account numbers, routing numbers, and user account names/passwords that the user can utilize to access the web portals of each of the financial institutions. Additionally, the user can be asked to input other information pertaining to their preexisting investments. For example, the user can be asked to input the type of investment, the duration of the investment, and/or the frequency in which the investment is altered.

In one embodiment, once the user inputs credentials to link to and access one or more preexisting investment accounts that are managed by one or more financial institutions, the ROI game-of-chance application 124 sends the user profile data to the ROI user accounts repository 110 to test web portal access to the one or more financial institutions by utilizing the credentials provided by the user (on the user profile). At step S508, the investment account credentials are utilized by the ROI user accounts repository 110 to access the financial intuition(s) through the financial institution(s) computing infrastructure 102 in order to acquire raw data pertaining to the user's preexisting investment account(s) that resides on the financial institution(s) databases 104.

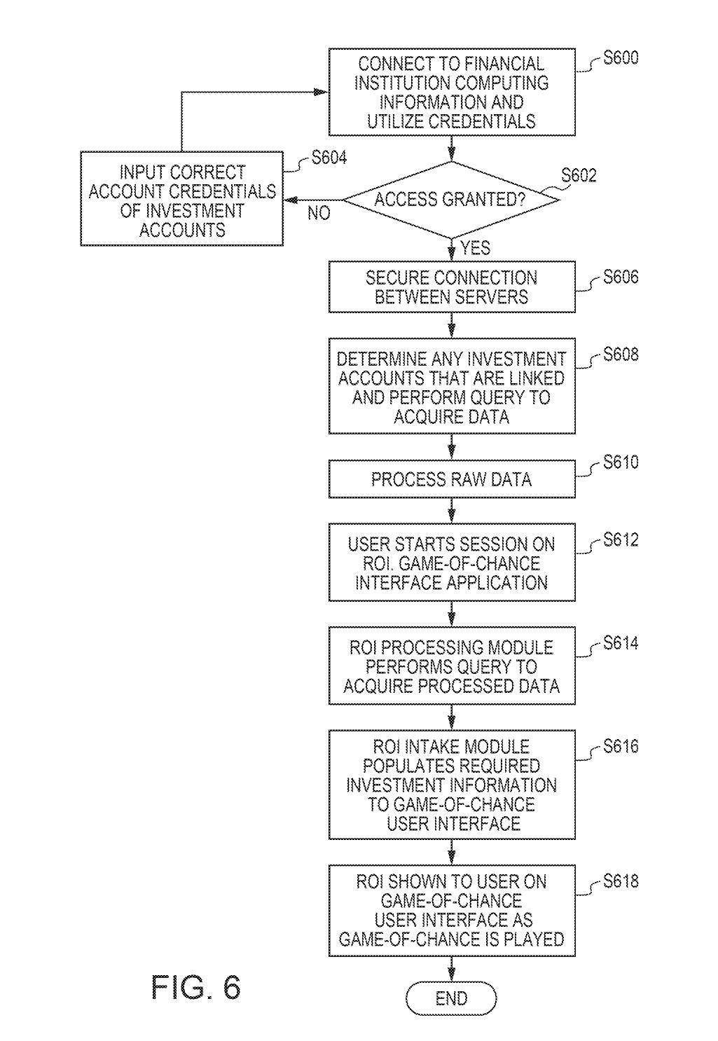

FIG. 6 is a process flow diagram of a method utilized to obtain and populate investment information utilized by an exemplary embodiment of the return on investment game-of-chance interface application 124. At S600, a connection is made to the financial institution(s) computing infrastructure 102 from the ROI user accounts repository 110 via a secure web-based connection (via the web portal) utilizing the credentials provided by the user on the user profile of the ROI game-of-chance interface application 124. At S602, it is determined during each connection if access is granted. For example, access can be have been granted at one point of time, but due to the user's changing of credentials at the financial institution, or a forced password change by the financial institution in regards to the user's investment account(s), access may no longer be granted.

If access is not granted (at S602) (i.e., the ROI user accounts repository 110 cannot access the financial institution(s) computing infrastructure 102), then at S604, the user is presented with an error message on the game-of-chance user interface asking the user to update the user profile by inputting correct account credentials of one or more preexisting investment accounts that are affected. Once the user updates the information, the process returns to S600 and the updated credentials are utilized by the ROI user accounts repository 110 to access the financial institution(s) computing infrastructure 102.

If access is granted (at S602) (i.e., the ROI user accounts repository 110 can access the financial institution(s) computing infrastructure 102), then at S606, a secure connection is created between the ROI repository server infrastructure 114 (along with the ROI repository databases 112) and the financial institution(s) server infrastructure 106 (along with the financial institution(s) databases 104). At S608, the ROI user accounts repository 110 communicates with the ROI game-of-chance interface application 124 and determines which of any preexisting investment accounts are linked via the user's profile. The ROI repository server infrastructure 114 connects to the financial institution(s) servers 106 and performs a query on the financial institution(s) databases 104 to acquire raw data pertaining to the (linked) preexisting investment account(s). In one embodiment, as soon as the user logs into the game-of-chance user interface 130, the ROI game-of-chance interface application 124 and the ROI user accounts repository 110 communicate to send over linked preexisting investment account(s) information in order for the ROI user accounts repository 110 to acquire the raw data pertaining to the preexisting investment account(s) (at step S608). At S610, one or more computer programs running on the ROI repository server infrastructure 114 are utilized to process the raw data. As discussed above, the raw data is processed in a format that can be utilized by the ROI game-of-chance interface application 124.

At S612, the user starts a session of the ROI game-of-chance interface application 124 in order to play one or more rounds of the game-of-chance via the game-of-chance user interface 130. At S614, the ROI processing module performs a query on the ROI repository databases 112 to acquire the processed data pertaining to the preexisting investment account(s) that are linked to the user profile. As mentioned, the processed data can contain data such as initial investment data, return on investment data, and other investment data from one or more preexisting investment accounts of various types of investments that are managed/maintained by one or more financial institutions.

At S616, the ROI intake module 128 derives the necessary information from the processed data acquired by the ROI processing module 126 and populates the required preexisting investment(s) information to the game-of-chance user interface 130. For example, when the ROI game-of-chance interface application 124 is used to view the user's return on investment as the winnings, the ROI intake module 128 can derive information such as the initial investment(s) value, the return on investment(s) value, the current total value of the preexisting investment(s). At S618 the required preexisting investment(s) information including the return on investment(s) is shown as winnings to the user on the game-of-chance user interface as the game-of-chance is played. The preexisting investment(s) information including the return on investment(s) can be shown in increments and/or the total value to the user as winnings between rounds and/or at the end of the session on the total investment returns screen.

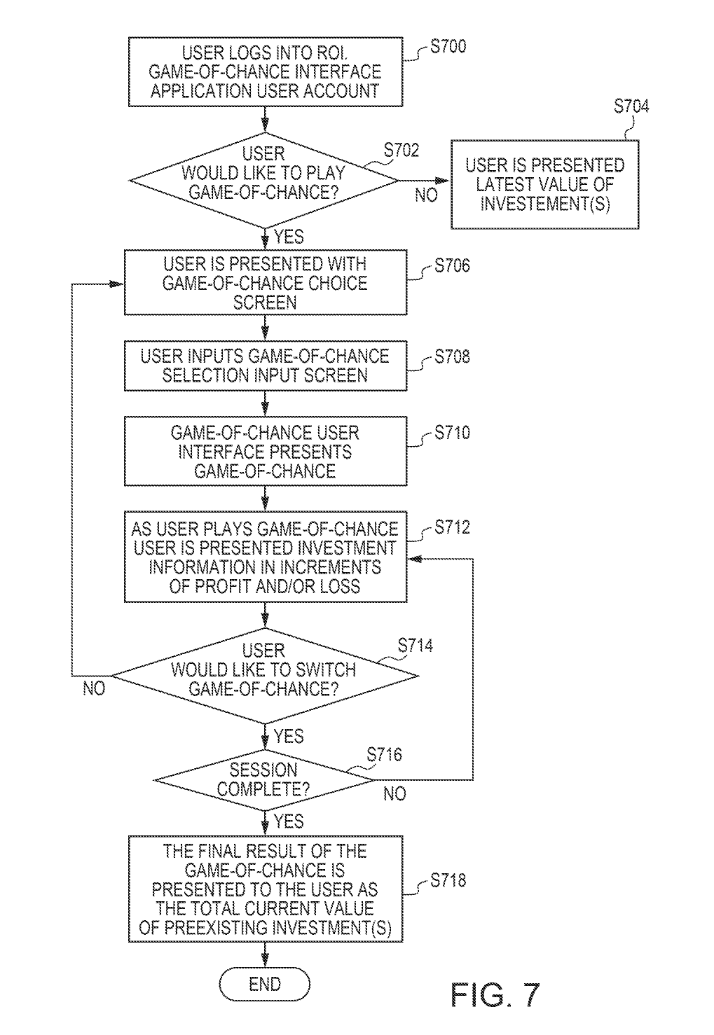

FIG. 7 is a process flow diagram of a method utilized during a session of the return on investment game-of-chance interface application 124. At S700 the user logs into the ROI game-of-chance interface application 124 with the user credentials. Upon login the user is presented with the game-of-chance user interface 130. The game-of-chance user interface initially presents the user with a yes/no question regarding if the user would like to play one of the game-of-chances. Additionally a user input icon can be presented to allow the user to edit the user profile (e.g., with new investment account details). At step S704, if the user decides he or she would not like to play the game-of-chance (at S702), the user is presented with the latest (i.e., current) value of his or her preexisting investments on the total investment returns screen that includes the return-on-investment(s). In one embodiment, if the user has multiple preexisting investment accounts, the user is presented with a choice to view each preexisting investment account value separately (as a separate line item) or the cumulative investments accounts value. Based on the user's preference, the user can review the latest information pertaining to his or her investment(s) that can be shown as values that are broken out per preexisting investment or cumulative values that pertain to combined investments.

At S706, if the user decides he or she would like to play the game-of-chance (at S702), the user is presented with a game-of-chance choice screen that includes game-of-chance choice selection input icons. The game-of-chance choice selection input icons can include input icons that show pictures of various game-of-chances with captions with the name of the game-of-chance underneath. For example, the game-of-chance choice selection input icon corresponding to the slot machine game-of-chance can include an image of a slot machine over the caption ‘Slot Machine Game.’ At S708, the user inputs the game-of-chance choice selection input icon based on his or her choice of which game-of-chance the user would like to play. Upon receiving the user's input, at S710, the game-of-chance user interface 130 presents the game-of-chance screen corresponding to the user's input. The user commences playing one or more rounds of the game-of-chance based party on the starting balance of tokens and the value of tokens the user utilizes per round.

At S712, as the user plays the game-of-chance, the user is presented investment information such as the (total or partial) value of the preexisting investment(s) (value of preexisting investment previously disclosed+the return on investment since the value of the preexisting investment was previously disclosed) as the winnings on the game-of-chance user interface 130. The game-of-chance interface application 124 ensures that the increments of the value of preexisting investment(s) shown to the user are broken out according to the value of tokens/expected number of remaining rounds within the session. In addition to presenting the game-of-chance, the game-of-chance user interface 130 can include ‘switch game-of-chance’ and ‘end session’ user input icons on one corner of the game-of-chance screen. If the user inputs the ‘switch game-of-chance’ icon, a confirmation message appears asking the user if the user would like to switch to a different game-of-chance at S714. If the user decides to switch the game-of-chance (at S714), the current game-of-chance ends, and the current token value is saved. At S706, the user is subsequently presented with the game-of-chance choice screen in order to select a different game-of-chance which will start with the current (saved) token value.

If the user decides not to switch the game-of-chance (the user does not confirm the request to switch to a different game-of-chance at S714) then the game-of-chance continues until the user exhausts all of his or her tokens within one or more rounds, or the user decides to input the ‘end session’ user input icon and end the session. At S716, it is determined if the session is complete due to the aforementioned reasons. In an exemplary embodiment, when the user inputs the ‘end session’ user input, a confirmation message appears asking if the user to confirm that the user would like to end the session. In one embodiment, once the user exhausts all of his or her tokens within one or more rounds, a message appears asking if the user would like to purchase more tokens or end the session. If it is determined that the session is not complete (i.e., the user would like to continue the session), then the user continues to play the game-of-chance and continues to be presented with investment information in increments of profit and/or loss at S712. At S718, if it is determined that the session is complete (at S716), the user is presented with the total investment returns screen and the final result of the game-of-chance is presented to the user as the total current value of the preexisting investment(s).

As discussed, various embodiments of the ROI game-of-chance interface system 100 can be utilized for the user to play the game-of-chance. It is to be appreciated that in addition to a stand alone local or web-based application, the ROI game-of-chance interface application 124 can be utilized on different types of platforms, computing infrastructure, and/or devices that are in production and that are not yet in production. For example, the ROI game-of-chance interface application 124 can be executed on a social media platform to be utilized as a social media platform specific application or plug-in.

The embodiments discussed herein can also be described and implemented in the context of computer-readable storage medium storing computer-executable instructions. Computer-readable storage media includes computer storage media and communication media. For example, flash memory drives, digital versatile discs (DVDs), compact discs (CDs), floppy disks, and tape cassettes. Computer-readable storage media can include volatile and nonvolatile, removable and non-removable media implemented in any method or technology for storage of information such as computer readable instructions, data structures, modules or other data. Computer readable storage media excludes non-transitory tangible media and propagated data signals.

It will be appreciated that various implementations of the above-disclosed and other features and functions, or alternatives or varieties thereof, can be desirably combined into many other different systems or applications. Also that various presently unforeseen or unanticipated alternatives, modifications, variations or improvements therein can be subsequently made by those skilled in the art which are also intended to be encompassed by the following claims.

What is claimed:

1. A method for revealing to investment account information including past returns of one or more of the user's preexisting investments, the method comprising:
providing a query to one or more databases to access and acquire investment account information of the user's preexisting investments;
obtaining, in response to the query, investment account information including the past returns of one or more of the user's preexisting investments;
populating the investment account information including the past returns of one or more of the user's preexisting investments to be accessed by a return on investment game-of-chance interface application; and
revealing the investment account information including the past returns of one or more of the user's preexisting investments to the user by operation of the return on investment game-of-chance interface application;
wherein the revealing of the investment account information includes revealing the past returns of one or more of the user's preexisting investments as though the past returns of one or more of the user's preexisting investments were the result of a game-of-chance played by the user on a game-of-chance user interface.

2. The method of claim 1, wherein the providing a query to one or more databases includes accessing one or more databases of one or more financial institutions and retrieving raw data that includes account information corresponding to one or more investment accounts of investment portfolios that include at least one of: securities, bonds, treasury bills, certificates of deposit, interest rate futures, stocks, stock options, equity futures, currency swaps, foreign exchange swaps, commodities, commodity futures, and commodity options.

3. The method of claim 2, wherein the providing a query to one or more databases includes accessing one or more databases of a return on investments user accounts repository and retrieving processed data that includes processed account information corresponding to one or more investment accounts to be utilized by the return on investment game-of-chance interface application.

4. The method of claim 1, wherein the obtaining the investment account information includes retrieving the user's account information that includes data regarding at least one of: user profile data, initial investment value, earnings, profits, losses, appreciation, depreciation, interest, return on investment, and account balance.

5. The method of claim 1, wherein the populating the investment account information includes populating the user's investment account information into at least one of: a database that resides on local memory and a database that resides on one or more external servers.

6. The method of claim 1, wherein the populating the investment account information includes populating the user's investment account information to the game-of-chance user interface to be shown to the user as winnings as the user plays the game-of-chance.

7. The method of claim 6, wherein the revealing the investment account information includes at least one of: revealing investment returns from one preexisting investment account for a period of time divided by increments of profit or loss based on the length of the one or more rounds of the game-of-chance, revealing cumulative investment returns from multiple preexisting investment accounts for a period of time divided by increments of profit or loss based on the length of the one or more rounds of the game-of-chance, revealing total investment returns from one preexisting investment account for a period of time at the end of one or more rounds or sessions of the game-of-chance, revealing total cumulative investment returns from multiple preexisting investment accounts for a period of time at the end of one or more rounds or sessions of the game-of-chance.

8. The method of claim 7, wherein the length of the one or more rounds or sessions of the game-of-chance is determined by at least one of: the value of tokens, the balance of tokens, the user's desire to utilize a number of tokens during each round, the required number of tokens to play each round, the user's desire to continue playing the game-of-chance.

9. The method of claim 7, wherein the revealing the investment account information includes revealing a total investment returns screen as a static representation of the investment account information upon the end of the session of the return on investment game-of-chance interface application.

10. A system for revealing to investment account information including past returns of one or more of the user's preexisting investments, the system comprising:
a return on investment game-of-chance interface application that is executed on a plurality of electronic devices;
a return on investment processing module that is included as a module of the return on investment game-of-chance interface application that provides a query to one or more databases to access and acquire investment account information of the user's preexisting investment accounts including past returns of one or more of the user's preexisting investments;
a return on investment intake module that is included as a module of the return on investment game-of-chance interface application that populates investment account information including past returns of one or more of the user's preexisting investments to be utilized by the return on investment game-of-chance interface application; and
a game-of-chance user interface that is included as a user interface of the return on investment game-of-chance interface application that reveals the investment account information including past returns of the one or more of the user's preexisting investments by operation of the return on investment game-of-chance interface application;
wherein revealing of the investment account information including the past returns is displayed as though the past returns of one or more of the user's preexisting investments were the result of a game-of-chance played by the user on the game-of-chance user interface.

11. The system of claim 10, wherein the return on investment processing module accesses one or more databases and retrieves the investment account information corresponding to one or more investment portfolios that include at least one of: securities, bonds, treasury bills, certificates of deposit, interest rate futures, stocks, stock options, equity futures, currency swaps, foreign exchange swaps, commodities, commodity futures, and commodity options.

12. The system of claim 10, wherein the return on investment processing module retrieves the investment account information that includes data regarding at least one of: user profile data, initial investment value, earnings, profits, losses, appreciation, depreciation, interest, return on investment, and account balance.

13. The system of claim 10, wherein the return on investment intake module populates the investment account information into at least one of: a data store that resides on local memory, a data store that resides on one or more external servers.

14. The system of claim 13, wherein the return on investment intake module populates the user's investment account information to the game-of-chance user interface to be shown to the user as winnings as the user plays the game-of-chance.

15. The system of claim 10, wherein the game-of-chance user interface includes graphical user interfaces, menus, screens, user interface inputs, and user interface outputs that are used to operate the game-of-chance.

16. The system of claim 10, wherein the game-of-chance user interface reveals at least one of: investment returns from one preexisting investment account for a period of time divided by increments of profit or loss based on the length of the one or more rounds or sessions of the game-of-chance, cumulative investment returns from multiple preexisting investment accounts for a period of time divided by increments of profit or loss based on the length of the one or more rounds or sessions of the game-of-chance, total investment returns from one preexisting investment account for a period of time at the end of one or more rounds or sessions of the game-of-chance, and total cumulative investment returns from multiple preexisting investment accounts for a period of time at the end of one or more rounds or sessions of the game-of-chance.

17. The system of claim 16, wherein the game-of-chance user interface reveals a total investment returns screen as a static representation of the investment account information upon the end of the session of the return on investment game-of-chance interface application.

18. A computer readable medium comprising instructions that when executed by a processor perform actions comprising:
providing a query to one or more databases to access and acquire investment account information of the user's preexisting investments;
obtaining, in response to the query, the investment account information including the past returns of one or more of the user's preexisting investments;
populating the investment account information including the past returns of one or more of the user's preexisting investments to be accessed by a return on investment game-of-chance interface application; and
revealing the investment account information including the past returns of one or more of the user's preexisting investments to the user by operation of the return on investment game-of-chance interface application;
wherein the revealing of the investment account information includes revealing the past returns of one or more of the user's preexisting investments as though the past returns of one or more of the user's preexisting investments were the result of a game-of-chance played by the user on a game-of-chance user interface.

19. The computer readable medium of claim 18, wherein the populating the investment account information includes populating the user's investment account information to the game-of-chance user interface to be shown to the user as winnings the user plays the game-of-chance.

20. The computer readable medium of claim 18, wherein the revealing the past returns of one or more of the user's preexisting investments includes at least one of: revealing investment returns from one preexisting investment account for a period of time divided by increments of profit or loss based on the length of the one or more rounds or sessions of the game-of-chance, revealing cumulative investment returns from multiple preexisting investment accounts for a period of time divided by increments of profit or loss based on the length of the one or more rounds or sessions of the game-of-chance, revealing total investment returns from one preexisting investment account for a period of time at the end of one or more rounds or sessions of the game-of-chance, revealing total cumulative investment returns from multiple preexisting investment accounts for a period of time at the end of one or more rounds or sessions of the game-of-chance.
